(19) United States
(12) Patent Application Publication
(10) Pub. No.: US 2013/0280477 A1
(43) Pub. Date: Oct. 24, 2013

(54) OFF-ANGLE LAID SCRIMS

(71) Applicants: Peter C. Davis, East Aurora, NY (US); David L. Spanton, Albion, NY (US); Lee D. Markle, Albion, NY (US); Philip Steggall, Jamestown, RI (US)

(72) Inventors: Peter C. Davis, East Aurora, NY (US); David L. Spanton, Albion, NY (US); Lee D. Markle, Albion, NY (US); Philip Steggall, Jamestown, RI (US)

(21) Appl. No.: 13/850,886

(22) Filed: Mar. 26, 2013

Related U.S. Application Data
(60) Provisional application No. 61/615,753, filed on Mar. 26, 2012.

(51) Int. Cl. B32B 5/12

(52) U.S. Cl. CPC B32B 5/12
USPC 428/109

(57) ABSTRACT

A nonwoven laid scrim includes a first carrier, an angled scrim overlying the carrier, and a second carrier overlying the angled scrim. The angled scrim includes at least one assembly of carbon fiber filaments. The nonwoven laid scrim has a main direction and a cross direction. The at least one assembly of carbon fiber filaments is oriented at an off-angle measured relative to the cross direction. The nonwoven laid scrim optionally includes a uni-directional fabric including a plurality of filaments, where the first carrier overlies the uni-directional fabric. At least two assemblies of filaments and a first cross direction yarn of the carrier also can define a multi-sided shape with at least three sides.

### CROSS-REFERENCE TO RELATED APPLICATION

The present application claims priority from U.S. Provisional Patent Application No. 61/615,753, filed Mar. 26, 2012, entitled “OFF-ANGLE LAID SCRIMS,” naming inventors Peter C. Davis, David L. Spanton, Lee D. Markle and Philip Steggall, which application is incorporated by reference herein in its entirety.

### FIELD OF THE DISCLOSURE

The present disclosure relates to laid scrims reinforced with assemblies of filaments oriented at an off-angle, including laid scrims with a uni-directional fabric and with multi-sided shapes.

### BACKGROUND

Laid scrims may have multiple layers, including subcomponents that form the base or carrier of such fabrics. Laid scrims may use an off-angle reinforcement that imparts certain properties for specialized applications. However, commercially available laid scrims may not provide the properties desired such as stability, durability, tensile strength, handling, or processability. Accordingly, a need continues to exist in the art for laid scrims to meet new and sometimes demanding applications.

### SUMMARY

In an embodiment, a nonwoven laid scrim includes a first carrier, an angled scrim overlying the first carrier, where the angled scrim includes at least one assembly of carbon fiber filaments, and a second carrier overlying the angled scrim, wherein the nonwoven laid scrim has a main direction and a cross direction, and wherein the at least one assembly of carbon fiber filaments is oriented at an off-angle measured relative to the cross direction.

In another embodiment, a nonwoven laid scrim includes a carrier and an angled scrim overlying the carrier, the angled scrim including at least one first assembly of filaments and at least one second assembly of filaments, wherein the nonwoven laid scrim has a main direction and a cross direction, and wherein the at least one first assembly of filaments is oriented at a first angle and the at least one second assembly of filaments is oriented at a second angle, wherein each of the first and second angles is an off-angle measured relative to the cross direction and wherein the first and second angles have distinct values.

In a further embodiment, a nonwoven laid scrim includes a uni-directional fabric including a plurality of filaments, a carrier overlying the uni-directional fabric, and an angled scrim overlying the carrier. The angled scrim includes at least one first assembly of filaments and at least one second assembly of filaments, wherein the nonwoven laid scrim has a main direction and a cross direction, and wherein the at least one first assembly of filaments is oriented at a first angle and the at least one second assembly of filaments is oriented at a second angle, wherein each of the first and second angles is an off-angle measured relative to the cross direction and wherein the first and second angles have distinct values.

### BRIEF DESCRIPTION OF THE DRAWINGS

Embodiments are illustrated by way of example and are not limited in the accompanying figures.

FIG. 1A includes a perspective view of an off-angle laid scrim illustrated in accordance with an embodiment described herein.

FIG. 1B includes an overhead view of the off-angle laid scrim of FIG. 1A in accordance with an embodiment described herein.

FIG. 2A includes a perspective view of an off-angle laid scrim illustrated in accordance with an embodiment described herein.

FIG. 2B includes an overhead view of the off-angle laid scrim of FIG. 2A in accordance with an embodiment described herein.

FIG. 3 includes an illustration of producing a nonwoven laid scrim in accordance with an embodiment described herein.

FIG. 4 includes a graph of the average laminar shear strength value obtained for both the conventional laminate product and the laminate product with the carrier layers with an embodiment described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

Before addressing details of the embodiments described below, some terms are defined or clarified. The term “filament” is intended to mean an elongated structure or fiber of any suitable length. The term “yarn” is intended to mean an ordered bundle of filaments. The term “scrim” is intended to mean a fabric that includes at least two filaments oriented in two different directions. For example, one or more filaments can be oriented in the “warp,” “main,” or “machine” direction that, in an embodiment, can be parallel to the length of the scrim. Another filament or filaments can be oriented in the “weft,” “fill,” “90,” or “cross” direction that, in an embodiment, can be parallel to the width of the scrim. The term “0/90 scrim” or “square scrim” is intended to mean a fabric in which at least one filament is oriented in the main direction parallel to the length of the scrim, at least one filament is oriented in the cross direction parallel to the width of the scrim, and the cross direction is perpendicular to the main direction. The term “laid scrim” is intended to mean a scrim in which at least one filament overlies at least one other filament to create the scrim. The term “off-angle” is intended to mean an angle that is measured relative to the cross direction, or the horizontal direction or width, of a scrim.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts.

In an embodiment, the present invention provides a nonwoven laid scrim including a carrier, an angled scrim overlying the carrier where the angled scrim includes at least one assembly of carbon fiber filaments, and another carrier overlying the angled scrim. The nonwoven laid scrim has a main direction and a cross direction, and the at least one assembly of carbon fiber filaments is oriented at an off-angle measured relative to the cross direction. In another embodiment, the present invention provides a nonwoven laid scrim including a carrier and an angled scrim overlying the carrier. The angled scrim includes at least one first assembly of filaments oriented at a first angle and at least one second assembly of filaments oriented at a second angle. The nonwoven laid scrim has a main direction and a cross direction and the first and second angles are each off-angles measured relative to the cross direction, where the first and second angles have distinct values. A nonwoven laid scrim as described herein can resist deformation in response to an applied load due to its increased fabric stability, can exhibit increased handling, durability, and tensile strength, and can also provide an aesthetic benefit due to a particular multi-sided shape or shapes present in the nonwoven laid scrim.

In a further embodiment, the present invention provides a nonwoven laid scrim with a uni-directional fabric including a plurality of filaments. The uni-directional fabric can be positioned underneath or over any suitable layer in the nonwoven laid scrim, including over or under one or more carriers, over or under one or more angled scrims, or interspersed between layers of assemblies of filaments within an angled scrim. The nonwoven laid scrim as described can be a single product that delivers the uni-directional fabric and the angled scrim in conjunction. A nonwoven laid scrim as described herein can resist deformation in response to an applied load due to its increased fabric stability, and can exhibit increased durability and tensile strength, from both the uni-directional fabric and the angled scrim. In addition, the nonwoven laid scrim is more easily handled and processed compared to commercially available fabrics without both the uni-directional fabric and the angled scrim.

The nonwoven laid scrim of the present invention provides for any suitable uni-directional fabric, which may be positioned in any reasonable orientation within the nonwoven laid scrim, including on top of and/or below any suitable carrier or angled scrim, and including being interposed between one or more layers of assemblies of filaments within an angled scrim. In an embodiment, the nonwoven laid scrim may not include a uni-directional fabric. In another embodiment, the nonwoven laid scrim may include more than one uni-directional fabric of similar or different materials, colors, or structure.

The uni-directional fabric of the nonwoven laid scrim includes a plurality of filaments. In an embodiment, the plurality of filaments of the uni-directional fabric are generally in a parallel direction. In a specific embodiment, the plurality of filaments may have a length that is oriented generally parallel to the main direction of the nonwoven laid scrim. “Generally parallel” as used herein refers to fibers or filaments that are angled less than 5 degrees, such as less than 1 degree, from a desired direction, including the main direction of the nonwoven laid scrim. More specifically, the plurality of filaments of the uni-directional fabric are oriented generally parallel across an entire width of the uni-directional fabric. In a particular embodiment, the plurality of filaments of the uni-directional fabric are spaced apart from each other by any suitable distance.

In an embodiment, the plurality of filaments of the uni-directional fabric can include one or more filaments of any suitable material. In a particular embodiment, the filaments may include an organic material, an inorganic material, or combination thereof. For instance, the filaments of the uni-directional fabric may include an organic material, an inorganic material, or combination thereof, such as a polyester, an aramid, an ultra high molecular weight polyethylene (UHMWPE) such as those available as Dyneema®, Spectra®, and MirAcle®, a poly(p-pheylene-2,6-benzobisoxazole) such as PBO Zylon®, an aromatic polyester such as Vectran®, a polyolefin such as those available from Innegra, a polyvinyl alcohol (PVA) such as those available from Teijin, a carbon, a Basalt fiber, a glass, or any combination thereof. The glass may be of any suitable composition or filament diameter or TEX such as E, C, AR, rovings of any TEX, twisted yarns of any TEX, fiber optic mono-filaments, combinations thereof, and the like. In an embodiment, the plurality of filaments can include a polyester filament, an aramid filament, a carbon fiber filament, or combination thereof. In a more particular embodiment, the plurality of filaments can include a carbon fiber filament.

Typically, the plurality of filaments for the uni-directional fabric may be in any suitable configuration. The plurality of filaments can also include various configurations of filaments within the uni-directional fabric. In an embodiment, the plurality of filaments can be configured to include an ordered or unordered bundle of filaments. In a particular embodiment, the plurality of filaments can include a flattened, substantially untwisted ribbon-like configuration, such as a tow or a tape. By “substantially untwisted,” it is meant that the plurality of filaments can include less than 0.5 twists per centimeter, such as less than 0.4, less than 0.25, or even less than 0.1 twists per centimeter. For example, the plurality of filaments can include a ribbon-like carbon fiber tow that includes a bundle of elongated and orderly carbon fiber filaments that are flattened and substantially untwisted. In another example, the plurality of filaments can be configured as an unordered bundle of filaments, such as a roving, or as an ordered bundle of filaments, such as a yarn with one or more plies. In both instances of a roving and a yarn, the configuration of the filaments may include any reasonable amount of twist applied to the filaments or bundle.

The configuration of the plurality of filaments for the uni-directional fabric can include various dimensions. In a particular embodiment, the plurality of filaments is generally uniform and homogenous in height and continuous across the entire width of the uni-directional fabric. For instance, the height of the plurality of filaments does not vary by more than 5% across the entire width of the uni-directional fabric.

The nonwoven laid scrim of the present application can include one or more suitable carriers. Any suitable position of the carrier is envisioned. For instance, when the uni-directional fabric is present, the carrier may overlie or be positioned underneath the uni-directional fabric. In an embodiment, the carrier directly contacts the uni-directional fabric. The carrier can include any reasonable substrate onto which or under which one or more assemblies of filaments, including one or more assemblies of filaments in an angled scrim, can be laid and supported. In an embodiment, the carrier can include any suitable material. For instance, the carrier may include an organic material, an inorganic material, or combination thereof, such as a polyester, an aramid, an ultra high molecular weight polyethylene (UHMWPE) such as those available as Dyneema®, Spectra®, and MirAcle®, a poly(p-pheylene-2,6-benzobisoxazole) such as PBO Zylon®, an aromatic polyester such as Vectran®, a polyolefin such as those available from Innegra, a polyvinyl alcohol (PVA) such as those available from Teijin, a carbon, a Basalt fiber, a glass, or any combination thereof. The glass may be of any suitable composition or filament diameter or TEX such as E, C, AR, rovings of any TEX, twisted yarns of any TEX, fiber optic mono-filaments, combinations thereof, and the like. In a particular embodiment, the carrier can include a material such as a polyester, such as a white polyester and/or a colored polyester, an aramid, or any combination thereof. Any suitable color or combination of colors is envisioned for the carrier. The carrier also can include any suitable configuration, including any suitable substrate configuration to support an angled scrim and the nonwoven laid scrim in general.

In an embodiment, the carrier can include a woven or nonwoven fabric having a certain configuration of yarns, such as a scrim and more particularly, a laid scrim. Any suitable configuration is envisioned for the laid scrim. In an exemplary embodiment, the carrier includes a nonwoven laid scrim, such as a nonwoven 0/90 scrim. For example, the carrier can include a first set of yarns, such as a plurality of polyester yarns or aramid yarns in one or more colors, or a combination of these yarns, extending generally parallel in a first direction of the nonwoven laid scrim. The carrier can also include a second set of yarns, such as another plurality of polyester yarns or aramid yarns in one or more colors, or a combination of these yarns, extending generally parallel in a second direction of the nonwoven laid scrim that is different than the first direction of the first set of yarns and that can overlie or lie underneath the first set of yarns. In an exemplary embodiment, the carrier can include a mix or blend of more than one yarn in at least one of the directions of the nonwoven laid scrim. For example, a carrier can be made with polyester and aramid yarns. Every fourth yarn in the second, or cross, direction can be an aramid yarn to increase the fill strength (e.g., the tensile strength in the cross or fill direction) of the carrier, including an increase in fill strength of at least 25%. Any suitable configuration other than a laid scrim also is envisioned for the carrier, including the use of one or more filamentary materials and the use of filaments in configurations other than that of yarns.

In a particular embodiment, the carrier can include a 0/90 scrim, where the cross direction of the scrim is generally perpendicular to the main direction of the scrim. The first set of yarns extend generally parallel in the main direction and the second set of yarns extend generally parallel in the cross direction. In an embodiment, the carrier includes at least one main direction yarn oriented parallel to the main direction of the nonwoven laid scrim and a first cross direction yarn oriented parallel to the cross direction of the nonwoven laid scrim. The first set of yarns can include a yarn spaced apart from and generally parallel to an adjacent yarn extending in the same direction by any suitable distance. The first set of yarns also can include the same or different distances between adjacent yarns. Similarly, the second set of yarns can include a yarn spaced apart from and generally parallel to an adjacent yarn extending in the same direction by any suitable distance. The second set of yarns also can include the same or different distances between adjacent yarns. In general, any suitable spacing is envisioned between adjacent yarns, depending upon the specific tensile and weight considerations required for a carrier. For example, yarns that are more closely spaced and that include a higher modulus and denier can create a stronger carrier. Yarn spacing can also be affected by the particular yarn material or materials used to meet an industrial specification. Moreover, the nonwoven laid scrim can include a variety of carriers, each of which can include different spacing between the yarns or filaments, and different yarn or filamentary materials.

The carrier of the nonwoven laid scrim can stabilize and support an angled scrim and can provide structure to the nonwoven laid scrim to enable handling of the scrim. Any number of carriers may be envisioned, including any suitable number of carriers in light of industrial considerations such as the overall areal weight of the nonwoven laid scrim. In an embodiment, the nonwoven laid scrim can include the optional uni-directional fabric, a first carrier, an angled scrim overlying the first carrier, and a second carrier overlying the angled scrim. In a further embodiment, at least one other assembly of filaments, such as a carbon fiber tow, can overlie the first carrier and can be oriented in a direction parallel to the main direction of the nonwoven laid scrim. In another embodiment, a carrier may be interposed between separate layers of assemblies of filaments within an angled scrim, on top of separate layers of assemblies of filaments, or both. For instance, the nonwoven laid scrim can include an optional uni-directional fabric, a first carrier, a first layer of at least one assembly of filaments at a first off-angle overlying the first carrier, a second carrier, a second layer of at least one assembly of filaments at a second off-angle overlying the second carrier, and a third carrier overlying the second layer of the at least one assembly of filaments. In a particular embodiment, each of the carriers can include a nonwoven laid scrim and, in particular, a 0/90 scrim. In another embodiment, the nonwoven laid scrim can consist essentially of a first carrier and an angled scrim overlying the first carrier. In a further embodiment, the nonwoven laid scrim can consist essentially of a first carrier, an angled scrim overlying the first carrier, and a second carrier overlying the angled scrim. In still another embodiment, the nonwoven laid scrim can consist essentially of a uni-directional fabric, a first carrier, an angled scrim overlying the first carrier, and a second carrier overlying the angled scrim. In an exemplary embodiment, the nonwoven laid scrim can consist essentially of a uni-directional fabric, a first carrier, a first layer of at least one assembly of filaments at a first off-angle overlying the first carrier, a second carrier, a second layer of at least one assembly of filaments at a second off-angle overlying the second carrier, and a third carrier overlying the second layer of the at least one assembly of filaments.

The nonwoven article further includes an angled scrim that overlies the carrier. In an embodiment, the angled scrim directly contacts the carrier. In a particular embodiment, the angled scrim is a nonwoven laid scrim. The angled scrim can include at least one assembly of filaments, such as at least one first assembly of filaments, oriented at any suitable angle. For instance, any suitable angle may be an off-angle measured relative to the cross direction of the nonwoven article. In an embodiment, the at least one assembly of filaments, such as the at least one first assembly of filaments, can be oriented at an off-angle between 5 degrees and 85 degrees, such as between 15 degrees and 85 degrees, or such as between 20 degrees and 80 degrees relative to the cross direction of the nonwoven article. In a particular embodiment, the at least one first assembly of filaments can be oriented at an off-angle of 20 degrees. In another particular embodiment, the at least one first assembly of filaments can be oriented at an off-angle of 30 degrees. In yet another particular embodiment, the at least one first assembly of filaments can be oriented at an off-angle of 45 degrees. Any suitable off-angle is envisioned.

Within the angled scrim, it is envisioned that the at least one first assembly of filaments can be oriented at a suitable off-angle (e.g., a first off-angle) and also can be oriented at a positive value, a negative value, or a combination thereof, of that off-angle. Any suitable positive or negative value of that off-angle is envisioned. For example, a positive or negative value of an off-angle can be an off-angle measured relative to the cross direction and relative to a particular orientation of the nonwoven laid scrim. In an embodiment, a positive value of an off-angle can be measured relative to the cross direction of the nonwoven scrim and relative to a side corresponding to the rightmost edge of the nonwoven laid scrim when viewing the scrim along its length. A negative value of an off-angle can be measured relative to the cross direction and relative to a side corresponding to the leftmost edge of the nonwoven laid scrim when viewing it along its length. For example, the at least one first assembly of filaments overlies a carrier and is oriented at a first off-angle (e.g., 45°), and also can be oriented at a positive value of the first off-angle (e.g., +45°), a negative value of the first off-angle (e.g., −45°), or a combination thereof.

Within the angled scrim, it is further envisioned that more than one assembly of filaments can be oriented at the off-angle and also can create a crossing angle where the assemblies of filaments cross over or under one another. Any suitable crossing angle is envisioned. In an embodiment, the crossing angle can be defined as 180 degrees minus twice the absolute value of a particular off-angle and can include any reasonable value between 0 and 140 degrees. For example, the at least one first assembly of filaments within the angled scrim can further include a first assembly of filaments that is oriented at a first off-angle (e.g., 45°) and that is oriented at a positive value of that off-angle (e.g., +45°). The at least one assembly of filaments can further include a second assembly of filaments also oriented at the first off-angle, but oriented at a negative value of that off-angle (e.g., −45°). The first and second assemblies of filaments can cross over or under one another within the angled scrim. In this instance, where the two assemblies of filaments cross, the first off-angle is 45 degrees and the crossing angle is 90 degrees.

The angled scrim also can include more than one assembly of filaments oriented at more than one off-angle. In an embodiment, the angled scrim can include the at least one first assembly of filaments oriented at a first off-angle as described above and at least one second assembly of filaments oriented at a second off-angle, wherein each of the first and second off-angles are measured relative to the cross direction. In an embodiment, the first off-angle and the second off-angle can have distinct values. For example, the first off-angle of the at least one first assembly of filaments can be 30 degrees and the second off-angle of the at least one second assembly of filaments can be 60 degrees. Such a combination of angles in the angled scrim can create a nonwoven laid scrim with isotropic strength. In an exemplary embodiment, the first off-angle of the at least one first assembly of filaments differs from the second off-angle of the at least one second assembly of filaments by at least 5 degrees, such as by at least 10 degrees. In another embodiment, the first off-angle of the at least one first assembly of filaments differs from the second off-angle of the at least one second assembly of filaments by no more than 90 degrees, such as by no more than 60 degrees.

It is envisioned that the at least one second assembly of filaments, which is oriented at the second off-angle (e.g., 60°), also can be oriented at either a positive (+60°) or negative (−60°) value of that second off-angle. Moreover, a second crossing angle can be defined as 180 degrees minus twice the absolute value of the second off-angle. For example, the at least one second assembly of filaments can further include a first assembly of filaments oriented at the second off-angle (e.g., 60°) and oriented at a positive value of that off-angle (e.g., +60°). The at least one second assembly of filaments can further include a second assembly of filaments that is oriented at the second off-angle but oriented at a negative value of that off-angle (e.g., −60°). The first and second assemblies of filaments can cross over or under one another within the angled scrim. In this instance, where the two assemblies of filaments cross, the second off-angle is 60 degrees and the crossing angle is also 60 degrees. In yet another embodiment, the angled scrim of the nonwoven laid scrim can include any suitable number or combination of off-angles, each off-angle being associated with one or more assemblies of filaments that can be oriented at positive or negative values of that off-angle. For example, an angled scrim can include a third off-angle, and the third off-angle can be associated with one or more assemblies of filaments that, in an embodiment, may be oriented at positive and/or negative values of the third off-angle and also may be oriented to cross over or under one another and create a third crossing angle.

It is further envisioned that the angled scrim can be symmetrical. For example, the angled scrim can include one or more assemblies of filaments oriented such that the angled scrim, and the nonwoven laid scrim, is symmetrical about a desired axis. Any suitable axis is envisioned. In an embodiment, the axis is parallel to a main direction of the nonwoven laid scrim. In another embodiment, the axis is parallel to a cross direction of the nonwoven laid scrim. For example, the angled scrim can include assemblies of filaments oriented at both positive and negative values of one or more off-angles (e.g., −30°, +30°, −60°, and +60°). The angled scrim can be symmetrical about an axis parallel to a main direction of the nonwoven laid scrim. The angled scrim further can be positioned within the nonwoven laid scrim such that the nonwoven laid scrim also is symmetrical about the axis parallel to the main direction.

In an exemplary embodiment, the at least one first assembly of filaments of the angled scrim can be spaced generally parallel from an adjacent first assembly of filaments and the at least one second assembly of filaments of the angled scrim can be spaced generally parallel from an adjacent second assembly of filaments. Any suitable spacing is envisioned between the at least one first assembly of filaments and the adjacent first assembly of filaments. Likewise, any suitable spacing is envisioned between the at least one second assembly of filaments and the adjacent second assembly of filaments. In general, any suitable spacing is envisioned between adjacent assemblies, including the same or different spacing between adjacent assemblies depending upon the specific tensile and weight considerations required for the angled scrim. For example, assemblies of filaments that are more closely spaced and that include a higher modulus and denier can create a stronger angled scrim. Assembly spacing can also be affected by the particular material or materials used in the angled scrim to meet an industrial specification. Moreover, the nonwoven laid scrim can include more than one angled scrim, each of which can include different spacing between the assemblies of filaments, and different filamentary materials.

Within any assembly of filaments oriented at an off-angle within the angled scrim, a majority of the filaments of the assembly can be oriented at the off-angle. For instance, the at least one first assembly of filaments includes a majority of filaments oriented at the first off-angle. The at least one second assembly of filaments includes a majority of filaments oriented at the second off-angle. In a particular example, the majority of the filaments can be oriented within 10 degrees of the off-angle of that particular assembly, such as within 5 degrees of the off-angle. In another embodiment, at least 75% of the filaments of an assembly of filaments can be oriented within 15 degrees of the off-angle of that assembly. For example, 75% of the filaments within the assembly of filaments can be within 10 degrees of the off-angle.

Each of the assemblies of filaments of the angled scrim can include, for example, one or more filaments of any suitable material. For example, the at least one first assembly of filaments can include an organic material, an inorganic material, or combinations thereof. The organic material, the inorganic material, or combination thereof for the angled scrim include, for instance, a polyester, an aramid, a ultra high molecular weight polyethylene (UHMWPE) such as those available as Dyneema®, Spectra®, and MirAcle®, a poly(p-pheylene-2,6-benzobisoxazole) such as PBO Zylon®, an aromatic polyester such as Vectran®, a polyolefin such as those available from Innegra, a polyvinyl alcohol (PVA) such as those available from Teijin, a carbon, a Basalt fiber, a glass, or any combination thereof. The glass may be of any suitable composition or filament diameter or TEX such as E, C, AR, rovings of any TEX, twisted yarns of any TEX, fiber optic mono-filaments, combinations thereof, and the like. In an embodiment, the at least one first assembly of filaments can include a polyester filament, an aramid filament, a carbon fiber filament, or combination thereof. In a more particular embodiment, the at least one first assembly of filaments can include a carbon fiber filament. It is further envisioned that the angled scrim can include any other suitable combination of filament materials. For example, industrial considerations such as ultraviolet degradation, chemical resistance (including resistance to alkaline chemicals), bonding behavior, and the amount of flexibility in the material can guide the decision to combine complimentary filament materials in the angled scrim. In an embodiment, the angled scrim can include a ultra high molecular weight polyethylene material, for its flexibility characteristics, and a carbon fiber material. In another embodiment, the angled scrim can include a polyolefin, such as those available from Innegra, for its ability to protect a laminate or composite product from impact and chemical breakdown. In yet another embodiment, the angled scrim can include Basalt, for its tensile strength, alkali resistance and natural fiber content, in combination with fiberglass, a polyolefin, or a ultra high molecular weight polyethylene material.

The at least one first assembly of filaments of the angled scrim can include a monofilament or it can include a number of filaments per assembly, such as greater than 50 filaments, greater than 100 filaments, greater than 200 filaments, greater than 500 filaments, or greater than 1,000 filaments. Typically, the assembly includes less than 300,000 filaments per assembly, such as less than 200,000 filaments or less than 100,000 filaments. A typical range can be 1,000 to 60,000 filaments per assembly.

Each of the assemblies of filaments for the angled scrim can include various configurations of filaments within each assembly. In an embodiment, the at least one first assembly of filaments can include a flattened, substantially untwisted ribbon-like configuration of organic filaments, inorganic filaments, or combination thereof, such as a tow or a tape. By “substantially untwisted,” it is meant that the assembly of filaments can include less than 0.5 twists per centimeter, such as less than 0.4, less than 0.25, or even less than 0.1 twists per centimeter. For example, the at least one first assembly of filaments can include carbon fiber filaments in a ribbon-like carbon fiber tow that includes a bundle of elongated and orderly carbon fiber filaments that are flattened and substantially untwisted. In another embodiment, the at least one first assembly of filaments can be configured to include an ordered or unordered bundle of filaments. For example, the at least one first assembly of filaments can be configured as an unordered bundle of filaments, such as a roving, or as an ordered bundle of filaments, such as a yarn with one or more plies. In both instances of a roving and a yarn, the configuration of the filaments may include any reasonable amount of twist applied to the filaments or bundle.

The configuration of each of the assemblies of filaments for the angled scrim can include various dimensions. For example, the at least one first assembly of filaments can include a cross-section that has an aspect ratio defined as a ratio of the width of the at least one first assembly of filaments to the height of the at least one first assembly of filaments. In an embodiment, the at least one first assembly of filaments can include an aspect ratio value less than 50:1, such as 10:1 for an assembly of filaments that includes 12,000 filaments. In another embodiment, the at least one first assembly of filaments can include an aspect ratio value greater than 2:1, such as 3:1, such as 5:1, or such as 7:1, or such as 10:1. Each assembly of filaments can have the same or different materials, number of filaments, configurations, aspect ratios, and the like depending on the properties desired for the angled scrim and ultimately, the nonwoven laid scrim.

Within the nonwoven laid scrim, a first cross direction yarn from a carrier, in conjunction with at least two assemblies of filaments oriented at one or more off-angles, can define a multi-sided shape with at least three sides. In an embodiment, the multi-sided shape can be defined by at least two assemblies of filaments, oriented at one off-angle, and any suitable number of cross direction yarns from the carrier, such as two cross direction yarns or three cross direction yarns. In another embodiment, the multi-sided shape can be defined by at least two assemblies of filaments, oriented at any suitable number of distinct off-angles such as a first and second off-angle, and the first cross direction yarn. It will be appreciated that the multi-sided shape can be defined by any suitable number of assemblies of filaments oriented at any suitable number of off-angles and any suitable number of cross direction yarns. A nonwoven laid scrim as described can provide an aesthetic (e.g., visual or stylistic) benefit due to a particular multi-sided shape or shapes being present in the nonwoven laid scrim.

It will further be appreciated that any suitable multi-sided shape or polygon is envisioned. For example, the multi-sided shape includes at least three sides and can include any suitable number of interior angles, where an interior angle includes an angle defined by two sides of the multi-sided shape that share an endpoint. An endpoint can include an intersection of two assemblies of filaments or an intersection of one or more assemblies of filaments with a cross direction yarn. In an embodiment, the multi-sided shape includes three sides, and can include shapes or polygons such as an equilateral triangle, an isosceles triangle, or a scalene triangle. The multi-sided shape with at least three sides can also include three interior angles where all three interior angles are the same (e.g., an equilateral triangle), two of the interior angles are the same (e.g., an isosceles triangle), or all three interior angles have different values. In another embodiment, the multi-sided shape includes at least four sides, including a shape or polygon such as a quadrilateral, and can include at least four interior angles having the same or different values. In a further embodiment, the multi-sided shape includes at least five sides, including a shape or polygon such as a pentagon, and can include at least five interior angles having the same or different values. In yet another embodiment, the multi-sided shape includes at least six sides, including a shape or polygon such as a hexagon, and can include at least six interior angles having the same or different values.

The multi-sided shape also can include geometric dimensions such as a length of at least one side of the multi-sided shape or a height of the multi-sided shape. Any suitable length or height is envisioned depending on the multi-sided shape that is desired. For example, the length of at least one side of the multi-sided shape can include a distance between a suitable first intersection and a suitable second intersection adjacent to the first intersection. In an embodiment, the second intersection is directly adjacent to the first intersection. Either the first intersection or the adjacent second intersection can include an intersection, such as a crossing underneath or an overlapping, of a cross direction yarn with one or more assemblies of filaments. In another embodiment, either the first intersection or the adjacent second intersection can include an intersection of two or more assemblies of filaments. In an embodiment, the height of the multi-sided shape can include any suitable distance, such as a distance between the first and second cross direction yarns.

The layers of the nonwoven laid scrim may be stabilized and fixed using various approaches. In an embodiment, any one of the uni-directional fabric, one or more carriers, the angled scrim, or combination thereof can include a coating to provide a bond between adjacent layers such as the uni-directional fabric and a carrier, the carrier and the angled scrim, the uni-directional fabric and the angled scrim, or combination thereof. For instance, the coating may be on one or both sides of the layer. In an embodiment, the uni-directional fabric, a first carrier and a second carrier may include the coating, with the angled scrim disposed between the first and second carrier.

In an embodiment, any suitable coating may be envisioned that provides a bond to an adjacent layer. In a particular embodiment, the coating can include an adhesive coating, such as a thermoplastic adhesive binder, a thermosetting adhesive binder, or any combination thereof. If desired, the coating can be non-tacky at room temperature. One advantage to the use of an adhesive coating when applied to one of the layers of the nonwoven laid scrim, such as a carrier, is its ability to increase the shear strength of a product (e.g., a laminated product or composite part) into which it is incorporated. A second advantage is that an adhesive coating provides less bulk or weight to the nonwoven laid scrim than stitching. Yet another advantage is that an adhesive coating can be applied to one or more layers of the nonwoven laid scrim during its production at a much faster rate than another means of stabilizing or fixing the layers of the nonwoven laid scrim (e.g., stitching) during its production. A still further advantage to using an adhesive coating is the stability that the adhesive coating affords to the nonwoven laid scrim. For example, using an adhesive coating enables the nonwoven laid scrim to be more versatile in end use applications, such as by allowing the nonwoven laid scrim to be placed into a mold (e.g., “preforming” the material) as part of a molding process before the introduction of a resin or resin system.

The same or different coating may be used to provide the bond between adjacent layers. In an embodiment, the bond between adjacent layers may be activated under conditions such as heat, pressure, or a combination thereof. During manufacturing, the nonwoven laid scrim may be heated to allow the coating of the uni-directional fabric, one or more carriers, or combination thereof to secure the layers of the nonwoven laid scrim to one another and to fix at the appropriate off-angle or off-angles each assembly of filaments within the nonwoven laid scrim, all of which can enhance the stability, durability, and strength of the nonwoven laid scrim. In a particular embodiment, the nonwoven laid scrim does not use stitching to secure any of the layers, whether the layer includes assemblies of filaments for an angled scrim, a carrier, a uni-directional fabric, or combination thereof, as the stitching can be an undesirable contaminant that does not add to the durability or strength of the final nonwoven laid scrim. In a further embodiment, the nonwoven laid scrim does not use a film to secure any of the layers. More specifically, the coating may be placed on the filaments of one or more layers, but is not a continuous film that covers any openings that may be present in one or more of the layers.

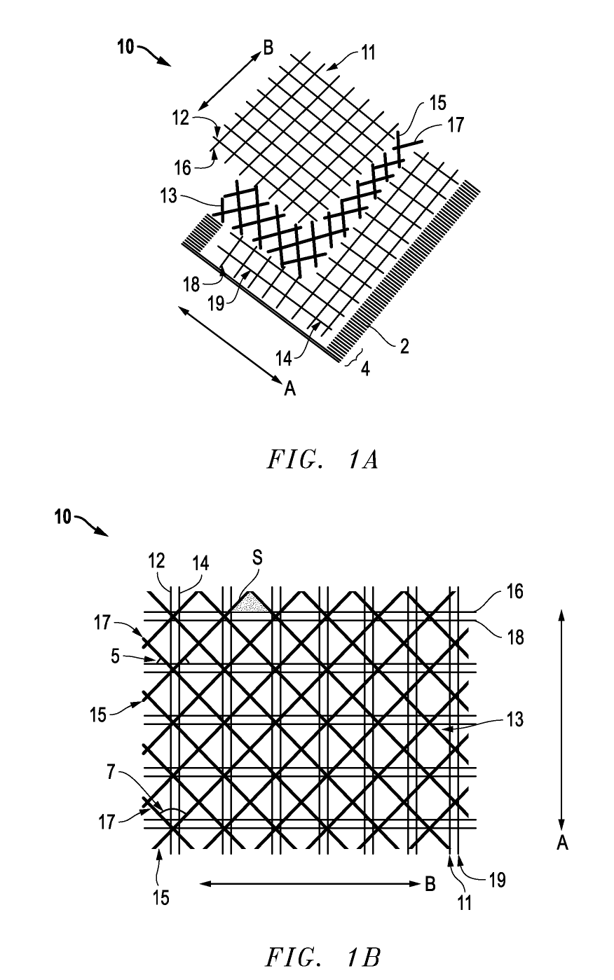

Turning to FIG. 1A, a nonwoven laid scrim is illustrated from a perspective view. The nonwoven laid scrim 10 includes a uni-directional fabric 2 that includes a plurality of filaments 4 that extend generally parallel to direction A of the nonwoven laid scrim 10. The uni-directional fabric 2 directly contacts carrier 19 and is adhered thereto by a coating (not shown). The two carriers 11 and 19 as illustrated include scrims, such as nonwoven laid scrims and, more particularly, 0/90 scrims. At least one yarn 12 from carrier 11 and at least one yarn 14 from carrier 19 can extend generally parallel to direction A of nonwoven laid scrim 10 which, in an embodiment, can include the main direction of nonwoven laid scrim 10. At least one yarn 16 from carrier 11 and at least one yarn 18 from carrier 19 can extend generally parallel to direction B of nonwoven laid scrim 10 which, in an embodiment, can include the cross direction of nonwoven laid scrim 10 and which can be perpendicular to direction A. Yarns 12, 14, 16, and 18 can include any suitable materials as described above and include any suitable configuration, whether including a single ply or multiple plies. In an embodiment, carriers 11 and 19 can include yarns that all include the same material such as polyester, or can include yarns that include different materials, such as alternating polyester yarns with aramid yarns. Further, carriers 11 and 19 can have the same or different configurations and yarns, depending upon the desired final properties of the nonwoven laid scrim 10.

An angled scrim 13 includes at least one first assembly of filaments 15 and 17 interposed between carrier 11 and carrier 19, for example by overlying carrier 19 and having carrier 11 overlie the at least one first assembly of filaments 15 and 17. In an exemplary embodiment, the at least one first assembly of filaments 15 and 17 further includes a first assembly of filaments 15 and a second assembly of filaments 17. The angled scrim 13 can directly contact both carriers 11 and 19 and the angled scrim 13 can be adhered to and fixed in place by a coating between carriers 11 and 19 and the angled scrim 13.

In an embodiment, the first assembly of filaments 15, the second assembly of filaments 17, or both, includes carbon fiber filaments. In a particular embodiment, the first assembly of carbon fiber filaments 15, the second assembly of carbon fiber filaments 17, or both, can include configurations such as a flattened, ordered and substantially untwisted tow with less than one twist per meter, such as less than 0.5 twists per centimeter. The first assembly of carbon fiber filaments 15 and the second assembly of carbon fiber filaments 17 can also include an off-angle measured relative to direction B of nonwoven laid scrim 10. In an embodiment, the first assembly of carbon fiber filaments 15 and the second assembly of carbon fiber filaments 17 include the same off-angle. The first assembly of carbon fiber filaments 15 can cross over or be crossed over by the second assembly of carbon fiber filaments 17 at a crossing angle. Although an angled scrim 13 with the at least one first assembly of filaments 15 and 17 is described, any number of assemblies of filaments can be envisioned at any off-angle envisioned. Further, any number of angled scrims can be envisioned, such as those laid between two or more carriers.

Although not illustrated, at least one other assembly of filaments can be disposed between carrier 19 and carrier 11 and can be oriented in a direction parallel to the main direction of the nonwoven laid scrim 10. The at least one other assembly of filaments may include fiber filaments of an organic material, inorganic material, or combination thereof such as a polyester, an aramid, a ultra high molecular weight polyethylene (UHMWPE) such as those available as Dyneema®, Spectra®, and MirAcle®, a poly(p-pheylene-2,6-benzobisoxazole) such as PBO Zylon®, an aromatic polyester such as Vectran®, a polyolefin such as those available from Innegra, a polyvinyl alcohol (PVA) such as those available from Teijin, a carbon, a Basalt fiber, or any combination thereof. In a particular embodiment, the at least one other assembly of filaments includes a carbon fiber tow (not shown), oriented in a direction parallel to direction A that can overlie carrier 19 and lie underneath carrier 11.

Turning to FIG. 1B, an overhead view of nonwoven laid scrim 10 from FIG. 1A is illustrated. Angled scrim 13, nonwoven laid scrim 10, or a combination thereof, can be symmetrical around a desired axis, such as an axis parallel to either of directions A or B. The angled scrim 13, including the first assembly of carbon fiber filaments 15 and the second assembly of carbon fiber filaments 17, can overlie carrier 19 and carrier 11 can overlie angled scrim 13 such that angled scrim 13 is interposed between carrier 19 and carrier 11. Although not shown, carrier 11, angled scrim 13, and carrier 19 can overlie the uni-directional fabric 2 having a plurality of filaments 4 from FIG. 1A. In an embodiment, yarn 12 can overlap yarn 14 and yarn 16 can overlap yarn 18. The at least one first assembly of filaments 15 and 17 can overlie carrier 19 at an off-angle 5 measured relative to direction B, which, in an embodiment, can include the cross direction of nonwoven laid scrim 10. More specifically, the first assembly of carbon fiber filaments 15 can overlie carrier 19 at a positive value of the off-angle 5. The second assembly of carbon fiber filaments 17 can overlie carrier 19 at a negative value of the off-angle 5. The first assembly of carbon fiber filaments 15 can intersect the second assembly of carbon fiber filaments 17, creating crossing angle 7, which is defined as 180 degrees minus twice the absolute value of the off-angle 5. For example, the absolute value of the off-angle 5 can be 50 degrees and the crossing angle 7 can be 80 degrees.

The nonwoven laid scrim 10 includes yarn 16, which can extend generally parallel to direction B of nonwoven laid scrim 10 and which, in an embodiment, can include the cross direction of nonwoven laid scrim 10 and which can be perpendicular to direction A. Yarn 16 and the angled scrim 13 (e.g., two assemblies of filaments from angled scrim 13) can define a multi-sided shape S with at least three sides. Multi-sided shape S is depicted in FIG. 1B as a triangle, but it is understood that multi-sided shape S can include any suitable shape or polygon with at least three sides. The interior of multi-sided shape S is further depicted as being shaded to distinguish it from first carrier 19 and angled scrim 13 in FIG. 1B, but it will be appreciated that the interior of multi-sided shape S can also be patterned, can be without shading, or can be transparent. In an embodiment, a side of multi-sided shape S can include a distance between a first intersection and an adjacent second intersection. In a particular embodiment, the adjacent second intersection is directly adjacent to the first intersection. For example, either the first intersection or the adjacent second intersection can include an intersection, such as a crossing underneath or an overlapping, of yarn 16 with one or more assemblies of filaments. In another embodiment, either the first intersection or the adjacent second intersection can include an intersection of two or more assemblies of filaments. In an embodiment, a height of multi-sided shape S can include a distance between, for example, yarn 16, and an intersection of two assemblies of filaments. Multi-sided shape S can also include various interior angles, such as three interior angles as shown in FIG. 1B. The interior angles of multi-sided shape S can have the same or different values. For example, two of the interior angles can be the off-angle 5, which can occur when the at least one first assembly of filaments 15 and 17 and yarn 16 are used to define multi-sided shape S. The third interior angle can be either the off-angle 5, and multi-sided shape S can include an equilateral triangle, or the third interior angle can include an off-angle value distinct from the off-angle 5 and multi-sided shape S can include an isosceles triangle.

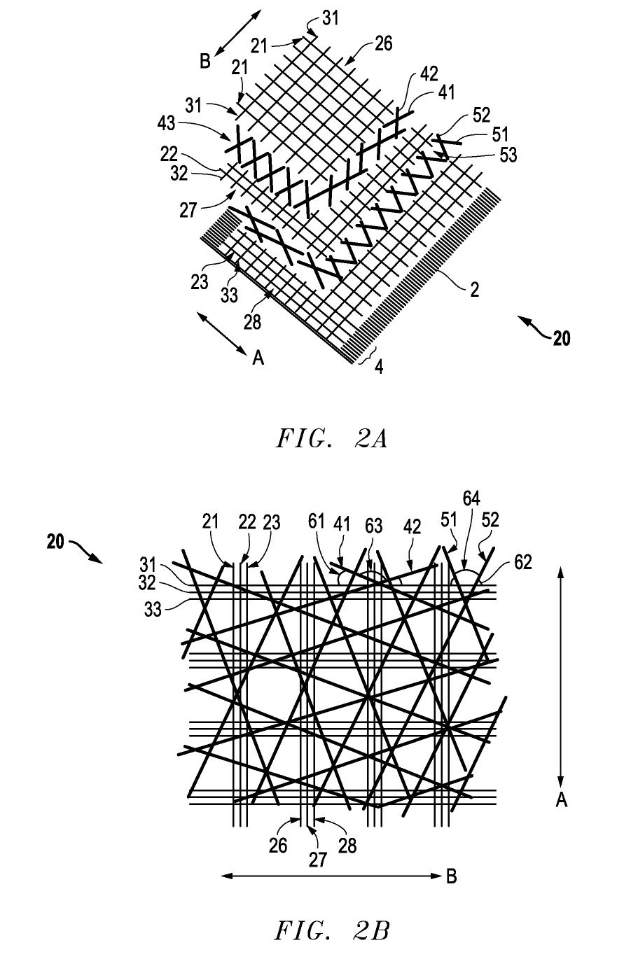

Turning to FIG. 2A, a nonwoven laid scrim is illustrated from a perspective view. The nonwoven laid scrim 20 includes a uni-directional fabric 2 that includes a plurality of filaments 4 that extend generally parallel to direction A of the nonwoven laid scrim 20. The uni-directional fabric 2 directly contacts carrier 28 and is adhered thereto by a coating (not shown). The nonwoven laid scrim 20 includes three carriers 26, 27, and 28, which as illustrated include scrims, such as nonwoven laid scrims and, more particularly, 0/90 scrims. At least one yarn 21 from carrier 26, at least one yarn 22 from carrier 27, and at least one yarn 23 from carrier 28 can extend generally parallel to direction A of nonwoven laid scrim 20 which, in an embodiment, can include the main direction of nonwoven laid scrim 20. At least one yarn 31 from carrier 26, at least one yarn 32 from carrier 27, and at least one yarn 33 from carrier 28 can extend generally parallel to direction B of nonwoven laid scrim 20 which, in an embodiment, can include the cross direction of nonwoven laid scrim 20 and which can be perpendicular to direction A. Yarns 21, 22, 23, 31, 32, and 33 can include any suitable materials as described above and include any suitable configuration, whether including a single ply or multiple plies. In an embodiment, carriers 26, 27, and 28 can include yarns that all include the same material such as polyester, or can include yarns that include different materials, such as alternating polyester yarns with aramid yarns. Further, carriers 26, 27 and 28 can have the same or different configurations and yarns, depending upon the desired final properties of the nonwoven laid scrim 20.

An angled scrim 53 includes at least one first assembly of filaments 51 and 52 interposed between carrier 27 and carrier 28, for example by overlying the at least one first assembly of filaments 51 and 52 onto carrier 28 and having carrier 27 overlie the at least one first assembly of filaments 51 and 52. In an exemplary embodiment, the at least one first assembly of filaments 51 and 52 further includes a first assembly of filaments 51 and a second assembly of filaments 52. The angled scrim 53 can directly contact both carriers 27 and 28 and the angled scrim 53 can be adhered to and fixed in place by a coating between carriers 27 and 28 and the angled scrim 53. The first assembly of filaments 51 and the second assembly of filaments 52 can also include an off-angle, such as a first off-angle measured relative to direction B of nonwoven laid scrim 10. In an embodiment, the first assembly of filaments 51 and the second assembly of filaments 52 include the first off-angle. The first assembly of filaments 51 can cross over or be crossed over by the second assembly of filaments 52 at a crossing angle, such as a first crossing angle. Although the angled scrim 53 is described with the at least one first assembly of filaments 51 and 52, any additional number of assemblies of filaments can be envisioned at any off-angle envisioned.

An angled scrim 43 includes at least one second assembly of filaments 41 and 42 interposed between carrier 26 and carrier 27, for example by overlying carrier 27 and having carrier 26 overlie the at least one second assembly of filaments 41 and 42. In an exemplary embodiment, the at least one second assembly of filaments 41 and 42 further includes a first assembly of filaments 41 and a second assembly of filaments 42. The angled scrim 43 can directly contact both carriers 26 and 27 and the angled scrim 43 can be adhered to and fixed in place by a coating between carriers 26 and 27 and the angled scrim 43. In a further embodiment (not shown), the angled scrim 43 can overlie both carrier 28 and the angled scrim 53 without carrier 27 being interposed within nonwoven laid scrim 20. The first assembly of filaments 41 and the second assembly of filaments 42 can also include an off-angle, such as a second off-angle, measured relative to direction B of nonwoven laid scrim 10. In an embodiment, the first assembly of filaments 41 and the second assembly of filaments 42 include the second off-angle. In a particular embodiment, the first off-angle and the second off-angle have distinct values. The first assembly of filaments 41 can cross over or be crossed over by the second assembly of filaments 42 at a crossing angle, such as a second crossing angle. In a particular embodiment, the first crossing angle and the second crossing angle have distinct values. Although the angled scrim 43 is described with the at least one second assembly of filaments 41 and 42, any additional number of assemblies of filaments can be envisioned at any off-angle envisioned.

Each of the assemblies of filaments within the nonwoven laid scrim 20 can include any suitable materials and configurations as described above, including a configuration such as an unordered twisted bundle (e.g., a roving), an ordered twisted bundle (e.g., a yarn), or a flattened, ordered and substantially untwisted tow with less than one twist per meter, such as less than 0.5 twists per centimeter.

Although not illustrated, at least one other assembly of filaments can be disposed either between carriers 26 and 27 or between carriers 27 and 28, where the at least one other assembly of filaments can be oriented in a direction parallel to the main direction of the nonwoven laid scrim 20. The at least one other assembly of filaments may include fiber filaments of an organic material, inorganic material, or combination thereof such as a polyester, an aramid, a ultra high molecular weight polyethylene (UHMWPE) such as those available as Dyneema®, Spectra®, and MirAcle®, a poly(p-pheylene-2,6-benzobisoxazole) such as PBO Zylon®, an aromatic polyester such as Vectran®, a polyolefin such as those available from Innegra, a polyvinyl alcohol (PVA) such as those available from Teijin, a carbon, a Basalt fiber, or any combination thereof. In a particular embodiment, the at least one other assembly of filaments includes a carbon fiber tow (not shown), oriented in a direction parallel to direction A that can overlie carrier 28 and lie underneath carrier 27, or can overlie carrier 27 and lie underneath carrier 26.

Turning to FIG. 2B, an overhead view of nonwoven laid scrim 20 from FIG. 2A is illustrated. Angled scrim 53, angled scrim 43, nonwoven laid scrim 20, or a combination thereof, can be symmetrical around a desired axis, including an axis parallel to either of directions A or B. The angled scrim 53, including the first assembly of filaments 51 and the second assembly of filaments 52, can overlie carrier 28 and carrier 27 can overlie the angled scrim 53 such that angled scrim 53 is interposed between carriers 27 and 28. The angled scrim 43, including the first assembly of filaments 41 and the second assembly of filaments 42) can overlie carrier 27 and carrier 26 can overlie the angled scrim 43 such that angled scrim 42 is interposed between carriers 26 and 27. Although not shown, carriers 26, 27, and 28, as well as angled scrims 43 and 53, can overlie the uni-directional fabric 2 having a plurality of filaments 4 from FIG. 2A. As a result, the angled scrim 53 can be interposed between yarns 22 and 23 and yarns 32 and 33, respectively, and the angled scrim 43 can be interposed between yarns 21 and 22 and yarns 32 and 33, respectively. In an embodiment, yarns 21, 22, and 23 can overlap and yarns 31, 32, and 33 can overlap. In an embodiment, carrier 27 can be removed such that the angled scrim 53 and the angled scrim 43 can overlie carrier 28 and lie under carrier 26.

The at least one first assembly of filaments 51 and 52 can overlie carrier 28 at an off-angle, such as first off-angle 62, measured relative to direction B, which, in an embodiment, can include the cross direction of nonwoven laid scrim 20. More specifically, the first assembly of filaments 51 can overlie carrier 28 at a negative value of the first off-angle 62. The second assembly of filaments 52 can overlie carrier 28 at a positive value of the first off-angle 62. The first assembly of filaments 51 can intersect the second assembly of filaments 52, creating first crossing angle 64, which is defined as 180 degrees minus twice the absolute value of the first off-angle 62. For example, the absolute value of off-angle 62 can be 60 degrees and the first crossing angle 64 can be 60 degrees.

The at least one second assembly of filaments 41 and 42 can overlie either carrier 27 or carrier 28 at an off-angle, such as second off-angle 61, measured relative to direction B, which, in an embodiment, can include the cross direction of nonwoven laid scrim 20. More specifically, the first assembly of filaments 41 can overlie carrier 27 at a negative value of the second off-angle 61. The second assembly of filaments 42 can overlie carrier 27 at a positive value of the second off-angle 61. The first assembly of filaments 41 can intersect the second assembly of filaments 42, creating second crossing angle 63, which is defined as 180 degrees minus twice the absolute value of the second off-angle 61. For example, the absolute value of the second off-angle 61 can be 30 degrees and the second crossing angle 63 can be 120 degrees.

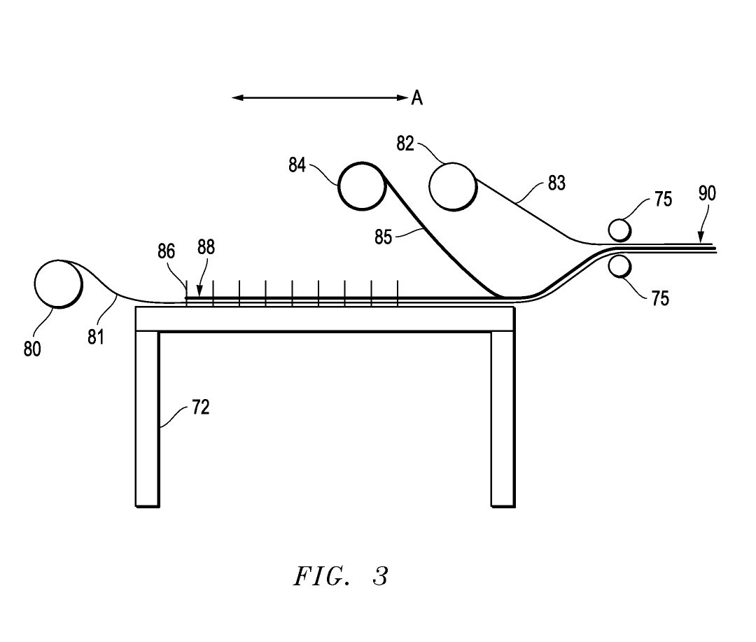

Turning to FIG. 3, a means of producing a nonwoven laid scrim 90 is illustrated. A table 72 or another flat, stationary surface can be provided upon which carrier 81 can be placed and supported. Table 72 can include any reasonable dimensions for making nonwoven laid scrim 90. For example, table 72 can be at least 100 centimeters wide, such as at least 125 centimeters wide or at least 150 centimeters wide, and table 72 can be any reasonable length, such as at least 100 centimeters, or at least 500 centimeters, or at least 1 meter. Carrier 81, which can include a scrim, such as a nonwoven laid scrim and can also include a 0/90 scrim, can be unrolled from an unwind stand 80 or any other reasonable storage means. At least one first assembly of filaments 88, such as carbon fiber filaments, can overlie carrier 81. To create a desired off-angle with the at least one first assembly of filaments 88, table 72 can be provided with one or more removable pegs 86 that can be moved and positioned at any reasonable point on table 72. At least one first assembly of filaments 88, such as a carbon fiber tow, can be wrapped or wound around or otherwise positioned relative to pegs 86 such that the at least one first assembly of filaments 88 overlie carrier 81 at any reasonable off-angle relative to the cross-direction of nonwoven laid scrim 90. The at least one assembly of filaments 88 can be spaced apart from and can, in an embodiment, be oriented generally parallel to, an adjacent assembly of filaments. Any suitable spacing is envisioned, including the same or different spacing between adjacent assemblies of filaments. In another embodiment, at least one second assembly of filaments can also be overlaid on carrier 81 using other pegs 86 to create another off-angle, with or without a carrier interposed between the at least one first assembly of filaments and the at least one second assembly of filaments. Once the at least one assembly of filaments 88 are positioned at the desired off-angle on carrier 81, uni-directional fabric 85 can be unrolled from an unwind stand 84 and can overlie the at least one first assembly of filaments 88. Alternatively, carrier 85 can be unrolled from unwind stand 84 to overlie the at least one first assembly of filaments 88. In a further embodiment, another carrier 83 can be introduced from an unwind stand 82 and can overlie the at least one first assembly of filaments 88 and uni-directional fabric 83. Alternatively, uni-directional fabric 83 can be introduced from unwind stand 82 and can overlie the at least one first assembly of filaments 88 and carrier 85 in a direction parallel to direction A, which can be parallel to a main direction of nonwoven laid scrim 90. The composite structure can travel through rollers 75 to complete nonwoven laid scrim 90.

In an embodiment, a coating, such as a thermoplastic adhesive binder or thermosetting adhesive binder that is desirably non-tacky at room temperature, can be placed on any surface of the uni-directional fabric 83 (or carrier 83), carrier 81, carrier 85 (or uni-directional fabric 85), or combination thereof to provide a bond between the uni-directional fabric 83, carrier 81, carrier 85 or combination thereof and its adjacent layer. Any method of providing the coating is envisioned and depends upon the coating chosen. In an embodiment, the nonwoven laid scrim 90 can be heated to activate the coating to allow the adhesive to stabilize the nonwoven laid scrim 90 and fix the uni-directional fabric 83, carrier 81 and 85, and the at least one first assembly of filaments 88 of the angled scrim. In a particular embodiment, the nonwoven laid scrim 90 does not include any stitching between carriers 81 or 85, the at least one assembly of filaments 88, or the uni-directional fabric 83, as the stitching can contaminate the nonwoven laid scrim 90 and does not contribute to its durability or strength.

A nonwoven laid scrim as described herein can be used to meet new and sometimes demanding applications in both the public and private sector. For example, the nonwoven laid scrims described can be used in military applications for fabrics that are ultra-light, highly resistant to tearing, capable of blocking heat signals, and easily transportable. The nonwoven laid scrim could be equally useful in commercial or private settings, such as in use in high performance camping gear and clothing fabrics designed to protect against natural elements or use in air cargo applications to provide lightweight containers and a lightweight means of reinforcing aerospace structures.

In recreational activities, nonwoven laid scrims as they have been described here can be used to reinforce and to enhance the performance and lifespan of ultra-light and stiff structures, such as snowboards, snowshoes, skis, canoes, hockey sticks, boats, yachts, kayaks, surfboards, stand up paddleboards, wake boards, skate boards, and kite boards. For example, one or more nonwoven laid scrims can be used as one or more layers of a composite material used for recreational activities. In an embodiment, one or more nonwoven laid scrims can be laminated to a core material or laminated into a composite material that includes a core. The nonwoven laid scrims can be positioned at variable distances from the core within the composite and can also be combined with other woven structures, such as woven fabrics including aramid, carbon fiber, and fiberglass filaments. In a particular embodiment, the nonwoven laid scrim including a uni-directional fabric, as described herein, can be used in particular applications such as baseball bats.

In the housing field, these nonwoven laid scrims can be used in fire retardant fabrics and heat signal blockage, as well as in building materials such as solar panels, decorative furniture, reinforced structures, and resistive under floor heating. From a public safety perspective, nonwoven laid scrims with off-angle reinforcement as described herein can be used to stop further damage to an area after a natural disaster or an explosion, to cordon off a damaged area from public access, to manufacture air bags in automobiles, or to create resistive heated roads.

More generally, the nonwoven laid scrim as described herein has applicability in a range of industrial fields. Panel structures, including multi-layered rigid panel structures and softer membrane panel, each can incorporate a nonwoven laid scrim of the present application. In an embodiment of a multi-layered rigid panel structure, the nonwoven laid scrim can be included in a multi-layer panel that also includes a core material of any suitable thickness, an optional “skin” layer of a woven fabric or a multiaxial fabric (e.g., a fabric of any suitable areal weight that can incorporate layers of fiberglass, aramid, or carbon fiber rovings or yarns that are applied parallel in direction, layered on top of one another in a variety of orientations relative to the machine direction of the fabric, and then stitched together), and any suitable matrix material for adhering one or more of the layers to an adjacent layer to form the panel, such as a resin system. The nonwoven laid scrim can be positioned in any suitable position within the panel to provide tensile strength, durability, and improved handling. For example, the nonwoven laid scrim can be positioned adjacent to either or both major sides of the core material, adjacent to a “skin” layer at the exterior major face of either or both sides of the panel, or can even be positioned at one or more exterior faces of the panel.

In an embodiment of a softer membrane panel, the nonwoven laid scrim as described herein can be laminated further to any suitable substrate, such as a film with an adhesive on it. In an embodiment, the nonwoven laid scrim can be bonded to a first film and then bonded to a second film, another scrim (whether or not the nonwoven laid scrim as described herein), or to another laminated or engineered fabric. In such a situation, the softer membrane panel incorporating the nonwoven laid scrim can include desirable tensile strength and prevention from deformation under tension, resistance to tearing, and even an aesthetic appeal or advantage over conventional panels. The laminated composite can then be used for suitable purposes including as a covering (e.g., a tent, a bandstand, an outdoor patio covering or other shield for sun protection in outdoor venues), or as a membrane (e.g., for fabrics in use with lighter than air balloons, unmanned flying machines, or transport vehicles).

The nonwoven laid scrim of the present application also has wide applicability to the field of composite parts, or components that include one or more layers of fabrics (e.g., woven fabrics) of one or more filament types/materials and that are bonded together with heat, pressure, a resin system, or a combination thereof. Common examples of composite parts can include trays, boxes, bridge supports, the body of a laptop computer, and intermediate parts of varying thicknesses used for structural support or intended for future machining. One or more nonwoven laid scrims, including one or more angled scrims, can be included in the composite part and can include a wide variety of filament configurations and materials, such as those described herein.

A further advantage to the nonwoven laid scrim of the present application is its aesthetic appeal. For example, the nonwoven laid scrim can incorporate one or more shapes (e.g., multi-sided shape S of FIG. 1B) in a particular pattern, including a graphic, repeating, or other unique pattern, which is appealing to and easily visually identified by consumers. In an embodiment, the color or type of materials employed in the nonwoven laid scrim can also impart a particular visual effect. The nonwoven laid scrim can incorporate this aesthetic appeal as part of a custom or unique product that is also tailored to the specific needs of a customer, such as a nonwoven laid scrim with one or more angled scrims oriented to provide certain structural reinforcement. For example, a nonwoven laid scrim made using dark materials (e.g., dark carrier yarns and dark assemblies of filaments) and used in conjunction with another substrate, such as a woven fiberglass fabric, can create an end product that can include both a desirable appearance and a structural advantage.

Yet another advantage is the ability of one or more carriers as described herein to enhance the shear strength of a rigid laminate product, such as a composite part made using carbon fabric. Historically speaking, it was believed that the addition of a carrier or other reinforcement coated with an organic binder (e.g., an adhesive coating as described above) to a laminate product would not only prove to be incompatible with the resin system used to make the finished laminate product, but would also act as a contaminant in the laminate product by lowering its shear strength. However, such a carrier does not act as a contaminant to the laminate product and can actually enhance the shear strength of the laminate product.

A conventional laminate product was made using 20 plies or layers of 300 g/sq. meter (gsm) carbon fiber fabric woven in an orthogonal, or 0/90, configuration. An epoxy resin system was used to laminate together the plies of carbon fiber fabric to form the conventional laminate product. The epoxy resin system was used with a 70 minute gel time and a viscosity of 220 centipoise. The conventional laminate product was infused at 77° F. under a 29.5″ Hg vacuum.

A laminate product that incorporated carriers as described herein was also made. More specifically, a carrier layer with an organic binder (e.g., a 0/90 laid scrim with polyester and a latex adhesive coating) was added after every layer or ply of carbon fiber fabric. The same epoxy resin system as described in connection with the conventional laminate product was used under the same conditions to obtain a finished laminate product with the carrier layers incorporated.

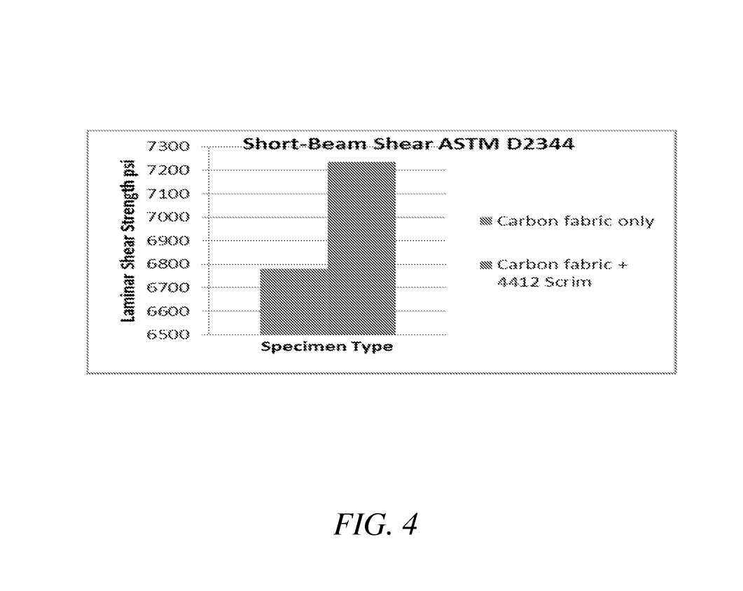

Both the conventional laminate product and the laminate product incorporating the carrier layers were tested in accordance with ASTM D2344 (“Standard Test Method for Short Beam Shear of Polymer Matrix Composite Materials and their Laminates) to obtain shear strength data. The testing was performed using an Istron 1350 RP Universal Testing Machine with Admet MTEST Quatro Digital Electronics, an Instron Load Cell, and Mitutoyo Digital Calipers. Laminar shear strength results were obtained for five specimens of the conventional laminate product, as shown below in Table 1. Laminar shear strength results were also obtained for five specimens of the laminate product incorporating the carrier layers (e.g., the “Carbon fabric+4412 Scrim”) as described and as shown below in Table 2. The average laminar shear strength value obtained for both the conventional laminate product and the laminate product with the carrier layers is plotted in FIG. 4.

TABLE 1

| Carbon Fabric | Max. | Width | Thickness | Laminar Shear |
|---|---|---|---|---|
| Only | load (lbsf) | (in) | (in) | Strength (psi) |
| Specimen 1 | 1625 | 0.6270 | 0.3100 | 6270 |
| Specimen 2 | 1821 | 0.6390 | 0.3295 | 6488 |
| Specimen 3 | 1903 | 0.6240 | 0.3045 | 7511 |
| Specimen 4 | 1781 | 0.6305 | 0.3160 | 6703 |
| Specimen 5 | 1973 | 0.6375 | 0.3350 | 6929 |
| Average | 1821 | 0.6316 | 0.3190 | 6780 |
| Standard | 132 | 0.0065 | 0.0129 | 476 |
| Deviation | | | | |

TABLE 2

| Carbon Fabric + | Max. | Width | Thickness | Laminar Shear |
|---|---|---|---|---|
| 4412 Scrim | load (lbsf) | (in) | (in) | Strength (psi) |
| Specimen 1 | 2073 | 0.6365 | 0.3240 | 7540 |
| Specimen 2 | 2112 | 0.6795 | 0.3320 | 7021 |
| Specimen 3 | 2293 | 0.7140 | 0.3320 | 7255 |
| Specimen 4 | 2272 | 0.6675 | 0.3380 | 7554 |
| Specimen 5 | 2026 | 0.6875 | 0.3245 | 6810 |
| Average | 2155 | 0.6770 | 0.3301 | 7236 |
| Standard | 120 | 0.0284 | 0.0059 | 325 |
| Deviation | | | | |

The laminate product including the carrier layers interspersed between layers of the woven carbon fiber fabric exhibits increased average shear strength as compared to the conventional laminate product. In an embodiment, the average shear strength is increased by at least 6.7%. The carrier layers with the organic binder (adhesive coating) on them did not act as a contaminant to the laminate product. In addition, the introduction of the carrier layer into the laminate product also reduces the cost of manufacturing the laminate product because the carrier layer is less expensive than a layer of the woven carbon fiber fabric.

Certain features, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A nonwoven laid scrim, comprising:
a first carrier;
an angled scrim overlying the first carrier, the angled scrim comprising at least one assembly of carbon fiber filaments; and
a second carrier overlying the angled scrim, wherein the nonwoven laid scrim has a main direction and a cross direction, and wherein the at least one assembly of carbon fiber filaments is oriented at an off-angle measured relative to the cross direction.

2. The nonwoven laid scrim of claim 1, wherein:
the first carrier comprises a first scrim;
the at least one assembly of carbon fiber filaments is not stitched to the first scrim; and
the second carrier comprises a second scrim, wherein the second scrim is not stitched to the at least one assembly of carbon fiber filaments.

3. The nonwoven laid scrim of claim 1, wherein the at least one assembly of carbon fiber filaments comprises greater than 50 carbon fiber filaments, such as greater than 200 carbon fiber filaments, such as greater than 500 carbon fiber filaments or greater than 1,000 carbon fiber filaments, or such as within a range of 1,000 to 50,000 carbon fiber filaments.

4. (canceled)

5. (canceled)

6. The nonwoven laid scrim of claim 1, wherein at least one of the first carrier and the second carrier comprises a coating to provide a bond between the carrier and the angled scrim.

7. The nonwoven laid scrim of claim 6, wherein the coating comprises a thermosetting adhesive binder, a thermoplastic adhesive binder, or any combination thereof.

8. The nonwoven laid scrim of claim 1, wherein at least one of the first carrier and the second carrier comprises a 0/90 scrim, and wherein the 0/90 scrim comprises:
a first set of yarns extending generally parallel to the main direction; and
a second set of yarns extending generally parallel to the cross direction and generally perpendicular to the main direction.

9. The nonwoven laid scrim of claim 1, wherein at least one of the first carrier and the second carrier comprises polyester, aramid, or combinations thereof.

10. The nonwoven laid scrim of claim 1, wherein the off-angle lies within a range of values between 20 and 80 degrees.

11. The nonwoven laid scrim of claim 10, wherein the off-angle further comprises a positive value, a negative value, or combination thereof.

12. The nonwoven laid scrim of claim 1, wherein a majority of the carbon fiber filaments of the at least one assembly of carbon fiber filaments are oriented at the off-angle.

13. (canceled)

14. (canceled)

15. The nonwoven laid scrim of claim 1, wherein the at least one assembly of carbon fiber filaments comprises a flattened, substantially untwisted tow.

16. The nonwoven laid scrim of claim 15, wherein the flattened, substantially untwisted tow includes less than 0.5 twists per centimeter, such as less than 0.25 twists per centimeter, or less than 0.1 twists per centimeter.

17. The nonwoven laid scrim of claim 15, wherein the flattened, substantially untwisted tow comprises a cross-section with an aspect ratio, wherein the aspect ratio is defined as a ratio of the width of the at least one assembly of carbon fiber filaments to the height of the at least one assembly of carbon fiber filaments, and wherein the aspect ratio has a value less than 50:1, such as 10:1.

18. The nonwoven laid scrim of claim 1, wherein the at least one assembly of carbon fiber filaments comprises:
a first assembly of carbon fiber filaments, wherein the first assembly of carbon fiber filaments comprises a plurality of filaments that are generally parallel to each other and that overlie the first carrier at a positive value of the off-angle; and
a second assembly of carbon fiber filaments, wherein the second assembly of carbon fiber filaments comprises a plurality of filaments that are generally parallel to each other and that overlie the first carrier at a negative value of the off-angle, and wherein the second assembly of carbon fiber filaments cross over the first assembly of carbon fiber filaments at a crossing angle.

19. The nonwoven laid scrim of claim 18, wherein the crossing angle is defined as (180 degrees−2*(the absolute value of the off-angle)), and wherein the crossing angle lies within a range of values between 0 and 140 degrees.

20. (canceled)

21. The nonwoven laid scrim of claim 1, further comprising at least one second assembly of carbon fiber filaments overlying the first carrier and oriented in a direction parallel to the main direction.

22. The nonwoven laid scrim of claim 1, wherein at least one of the angled scrim and the nonwoven laid scrim is symmetrical about an axis.

23. The nonwoven laid scrim of claim 22, wherein the axis is parallel to the main direction or the cross direction of the nonwoven laid scrim.

24. The nonwoven laid scrim of claim 1, further comprising a uni-directional fabric comprising a plurality of filaments, wherein the first carrier overlies the uni-directional fabric.

25. A nonwoven laid scrim, comprising:
a uni-directional fabric comprising a plurality of filaments;
a first carrier overlying the uni-directional fabric;
an angled scrim overlying the first carrier, the angled scrim comprising at least one assembly of carbon fiber filaments; and
a second carrier overlying the angled scrim, wherein the nonwoven laid scrim has a main direction and a cross direction, and wherein the at least one assembly of carbon fiber filaments is oriented at an off-angle measured relative to the cross direction.

26. (canceled)

27. (canceled)

28. (canceled)
